(19) United States
(12) Patent Application Publication
(10) Pub. No.: US 2008/0062168 A1
(43) Pub. Date: Mar. 13, 2008

(54) Method For Bulk Provision Of Interactive Virtual Visits For Multimedia Broadcast, And System Therefor

(76) Inventors: David Poullier, Amiens (FR); Olivier Brion, Saint-Cloud (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/815,910

(22) PCT Filed: Feb. 9, 2005
(86) PCT No.: PCT/FR05/00293

§ 371 Date: Sep. 20, 2007

(51) Int. Cl. G06T 15/00

(52) U.S. Cl. 345/419

(57) ABSTRACT

The invention concerns a delocalized fast and easy-to-implement system for automatically creating virtual visits enabling a very large amount of data to be simultaneously processed. Therefor, the invention concerns a digital processing system comprising: an interface viewable on a device such as a computer equipped with a network connection, to collect information and data, and to send files; a remote unit for receiving and storing processing files and data connected by a communication network to the interface; at least two data processing units, connected in parallel to the reception and storage unit, each processing unit including a database and a digital processing circuit adapted to detect the presence of a new processing file, and to reserve access for itself to said new file, to process the data based on the information contained in the database and in the processing file in order to create a virtual visit, and to provide the virtual visit to the user.

The invention relates to a method for the bulk production of interactive virtual visits for multimedia broadcast, and a system for implementing such a method.

The production of virtual visits is a method that is increasingly widely used thanks to the growth of communication networks such as the Internet and cellphone networks conveying images.

A virtual visit enables a user to move virtually, fluidly and continuously, in a remote location, such as an apartment, and view it from several angles as if he were actually there and looking around this location to view it all.

The interest in such virtual visits is to give the user an idea of space that a simple series of static photographs is incapable of suggesting. A user can thus move virtually in a hotel room before booking it, visit an apartment before renting it for the holidays or make an initial selection of apartments before an actual visit, and so on.

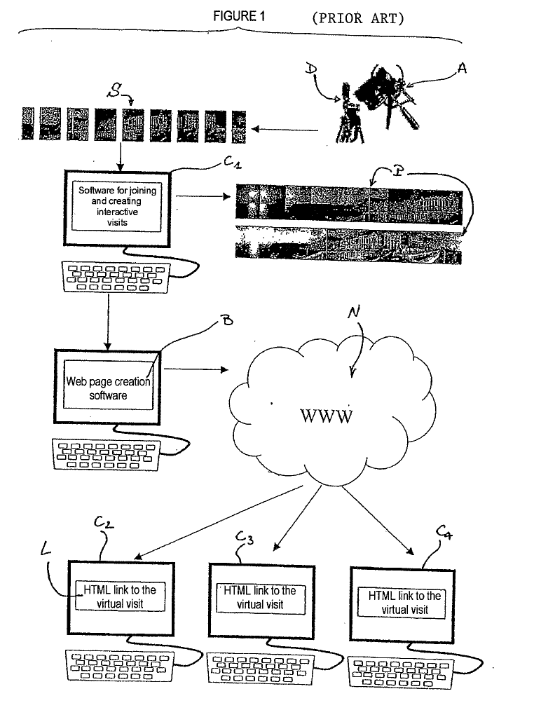

A known method of creating virtual visits by a user is represented in FIG. 1.

Before any description, it is important to refer to the definitions given below concerning the technical terms used hereinafter:
digital snapshot (or image): this is a digital photograph taken with a digital camera;
wide-angle image: an image obtained by a lens with a focal length less than 50, that is, covering an angle greater than 47°;
fisheye format image: a fisheye image is a photograph which has been taken with a special very-wide-angle lens (180°×180°) called fisheye lens; the image taken is circular, in the form of a disk;
panoramic format image: this is a rectangular image having a wide viewing angle; a panoramic image is the result of several digital snapshots placed one alongside the other;
360×180 type image: this is an image which has a field of vision of 360° horizontally and 180° vertically: this is the result obtained by jointly processing two fisheye images;
180×180 type image: this is an image which has a field of vision of 180° horizontally and 180° vertically: this is the result of processing a single fisheye image or a panoramic image covering a field of vision of 180°;
equirectangular image: an equirectangular image is the result of processing a circular image and a rectangular image, the width of which is equal to one or two times its height;
fixed image: an image having the format of a digital snapshot (4/3 ratio);
thumbnail image: a fixed image whose size has been reduced;
joining program: program used to place several digital snapshots end-to-end in as much as these snapshots correctly follow each other; by using a joining program, panoramic images are obtained from multiple digital snapshots;
applet: a small application (or program) independent of the hardware and of the software used, which can be downloaded from a network server and executed locally within a browser program, or which can be executed directly from the server; applets are mainly employed in the Java or Flash programming language;
display program; a Java applet or Flash applet which makes it possible to read large-size panoramic images to go to the right, the left, up and down in the image; with these display programs, it is possible to scan the image, giving the impression of running a short film on which it is possible to interact;
virtual visit: the result obtained when a series of panoramic images are grouped together and read in a display program;
web page: an interface of an Internet network server.

The known method consists in using a digital camera A to take a series S of photographs which follow on from each other in space, and producing on a computer C1 a collage P of these photographs using a dedicated program in order to obtain a panoramic image. The user must then create a web page B in HTML format, incorporating in it a dynamic display program and publishing it on the Internet network. The hypertext link L of the virtual visit stored on his computer is stored on this page B so that other users can display it, activate this link L and view the virtual visit on their computer C2, C3 and C4.

Each of these steps is highly complex. In practice, the exposure requires an excellent technical mastery with, in particular, the use of a stand D provided with a ball joint so that the digital camera can be swiveled about a fixed point called nodal point. Then, the succession of photographs S must be taken, with an overlap so there is no risk of discontinuities in the areas of the landscape being photographed. The area of superimposition should, preferably, represent 20% to 50% between the photographs to facilitate the joining of the photographs, particularly with regard to color correction. It is therefore important to spend a considerable amount of time in this step in order not to risk rendering the virtual visit unusable.

Creating the panoramic image entails owning and mastering an image processing program on the computer C1. The user chooses the series S of snapshots, the parameters to be taken into account and runs the program so that the latter can join each of the images of the series S end-to-end to create a final image P which combines all the snapshots.

Another solution consists in taking a snapshot with a very-wide-angle viewing lens, of fisheye type, but this requires even greater mastery of the image processing program and of image distortion effects to obtain a usable virtual visit.

Once the various panoramic images P have been created with the joining program, the user must publish it on a website. For this, he must create the web page B, incorporating therein a display program (normally a Java applet) that he parameterizes using a script file. Once this page B has been created, he uses a file transfer protocol (FTP) to transfer to his web server N all the component elements of his virtual visit, namely: the panoramic images P created, that he places in a dedicated directory, page B, the display program and the parameterizing file. If the user has the benefit of the services of a website administrator, all he needs to do is to send (typically by email) all of these elements and the site administrator will handle publication himself.

This process is very widely used by real estate agencies present on the Internet and/or professional photographers who produce virtual visits.

Regarding publication on the Internet, some joining programs make it possible to dynamically create the HTML page and parameterize the display program, using a function for transferring the panoramic images that have been created to a server.

The state of the art does not enable just anyone to create a virtual visit and publish it on the Internet, because he must have at least the following techniques:
photographing techniques with a stand to be able to create an effective series of snapshots that follow on from each other;
installing a program on his computer which may, for some users, include installation problems;
using an image processing program that is often too complex for the uninitiated;
being able to create an HTML page and/or configure a display applet (Java or Flash);
as appropriate, being able to use an FTP account.

Having all of these techniques makes it impossible, for most users, to use the virtual visit other than by calling in an external service provider with a mastery of all of these techniques. These service providers are more often than not professional photographers and/or Internet agencies specializing in creating virtual visits, who produce the virtual visits for their customer one after the other.

These techniques are also costly, in hardware, program and time terms.

Also, in the real estate world, few real estate agencies use the virtual visit because it is too complicated to implement and/or too costly when a subcontractor is called in.

Furthermore, each specialist service provider can produce only a limited number of virtual visits, successively, according to his IT installed base.

To this end, the present invention proposes to overcome these drawbacks by providing a method for the bulk production of virtual visits and an implementation system, that are fast and easy to use and allow for simultaneous processing of a very large quantity of data by relocation, and in which all the interactions are conducted on line, the user handling only the photography and the virtual visit being created with a view to being published subsequently, for example on a website, by email or transmitted to a cellphone.

More specifically, the subject of the invention is a method for the bulk production of interactive virtual visits for multimedia broadcast based on at least one image selected by a user having a computer provided with a network connection, comprising steps consisting in:
(a) receiving, on a remote reception and storage unit, via an interface that can be displayed on the computer provided with a network connection, all the images taken with digital cameras provided with a wide-angle lens,
(b) automatically detecting the format of each image;
(c) creating at least one processing file associated with at least one image on reception comprising information concerning the image format and characteristics and at least one processing operation to be performed;
(d) performing a scan that is automatic and at a regular frequency of the reception and storage unit with at least one processing unit operating simultaneously, to immediately detect the presence of each new processing file associated with one or more images;
(e) as soon as a processing unit detects a new processing file, this processing unit renames it automatically and uniquely in order to avoid redundant processing by another processing unit, if at least two processing units are used;
(f) processing as a continuous stream the associated image or images according to the processing read by the processing unit in the processing file, to perform a correction of distortion of the image so that it can be read as a virtual visit by a display program;
(g) making the virtual visit available to the user.

One advantage of the invention is its ease of use, since all the complex, long and restrictive operations involved in creating virtual visits are performed on remote servers. The user simply takes the photographs and downloads them, direct from his digital camera via a computer having a network connection, to the system. The rest of the operations are carried out automatically: conversion of the image and dynamic creation of the virtual visit ready to be sent to a website, an email address or a cellphone.

With the invention, the user no longer needs to have a single one of the techniques stated previously. All that is needed is for him to be a simple web surfer to produce a virtual visit and place it on line. From the creation to the publication of a virtual visit, the user uses only his mouse and, by clicking icons or web links, he creates his virtual visit and uses it as he wishes.

Also, the invention enables a user resistant to new technologies, or who is a bad learner of the IT computer tool, to create and use the virtual visit in a few clicks and in a few minutes.

Processing a bulk quantity of information—or data—requires, in the state of the art, numerous isolated processing systems. The invention makes it possible not only to process a large quantity of information centrally and automatically, but it also saves significant time (of the order of 10% to 50% depending on the image transfer and processing conditions) because the information is processed simultaneously instead of successively.

In other words, the invention aims to “industrialize” the creation of virtual visits, whereas in the state of the art it is performed manually, in isolation and independently. However, the invention is not the simple adding together of the isolated systems of the state of the art because it also increases the speed of processing of each virtual visit.

The invention also makes it possible to easily update and upgrade the system because each update is automatically passed on to all the users.

The invention also relates to a digital processing system for implementing the above method, comprising:
an interface that can be displayed on a device such as a computer provided with a network connection, for collecting information and data and sending files;
a remote reception and storage unit for information files and data files linked by a communication network to the interface;
at least two data processing units, linked in parallel to the reception unit, each processing unit comprising a database and a digital processing circuit able to detect the presence of a new processing file, reserve access to this new file, process the file according to the information contained in the database and in the processing file to create a virtual visit, and make the virtual visit available to the user.

According to one embodiment, a system according to the invention has an architecture that can be varied by using for example a variable number of blades of a blade server as the reception and/or processing unit.

It is then possible on the one hand to increase the processing capacity simply and inexpensively, and on the other hand to reproduce such a system in multiple copies, without risk of data confusion, whether on the scale of a user group or on the world scale of the Internet network or cellphone networks.

Particular embodiments of the invention are defined in dependent claims. Other characteristics of the invention will be stated in the detailed description below given with reference to the appended figures which respectively represent:

FIG. 1, a diagrammatic view of the structure of a system according to the state of the art;

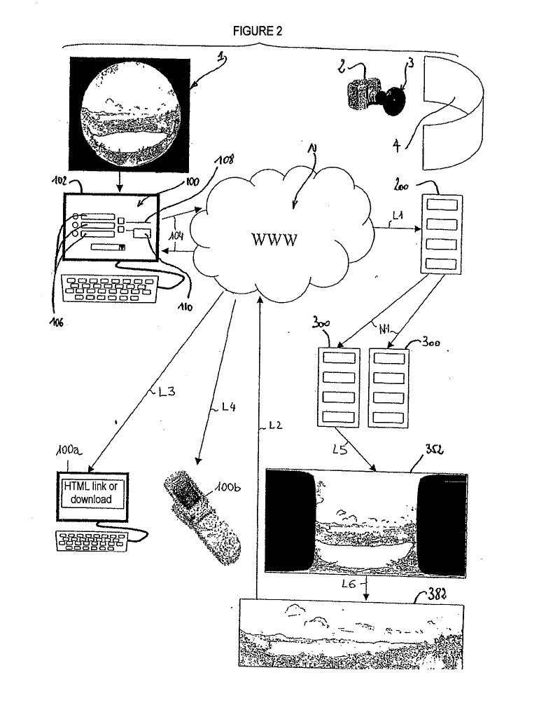

FIG. 2, a diagrammatic view of the structure of a system for creating virtual visits according to the invention;

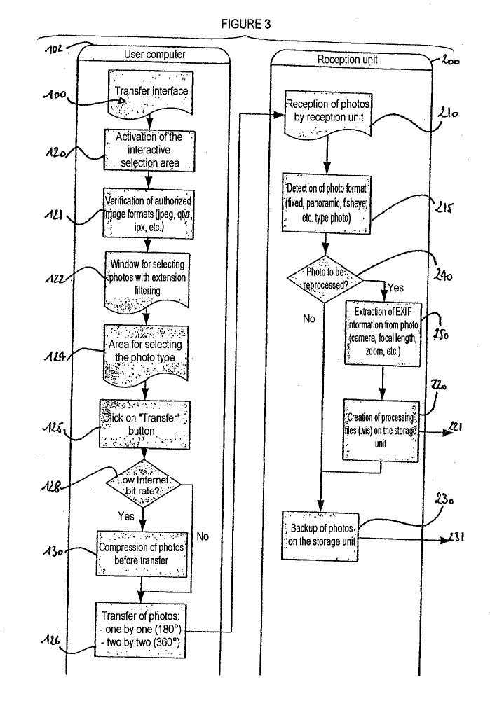

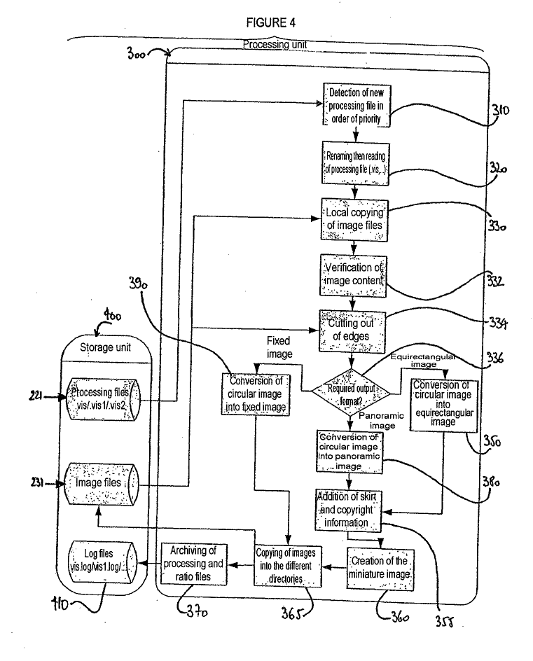

FIGS. 3 and 4, an operating chart of a system for creating virtual visits according to the invention;

FIG. 5, a diagrammatic view of a fisheye image, with the black edges deleted;

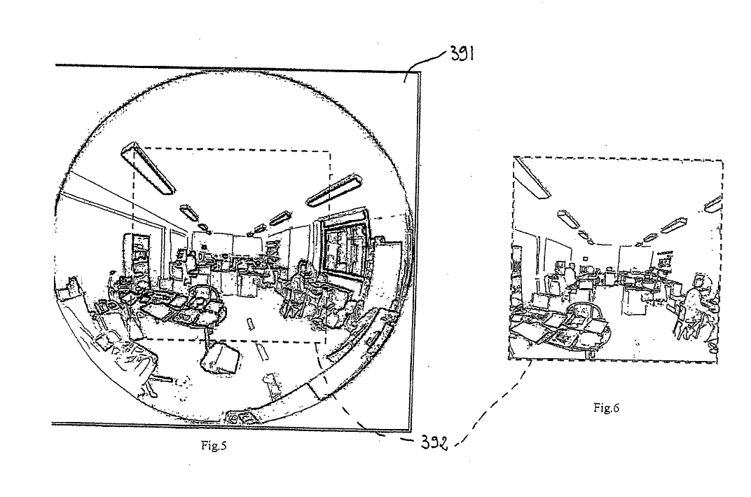

FIG. 6, a diagrammatic view of an image extracted from the fisheye image of FIG. 5;

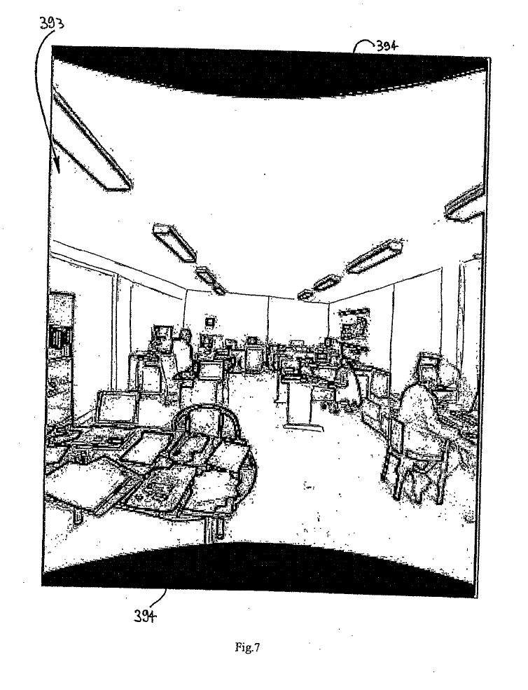

FIG. 7, a diagrammatic view of a cylindrical projection of the image of FIG. 6;

FIG. 8, a diagrammatic view of a fixed image obtained from a system according to the state of the art;

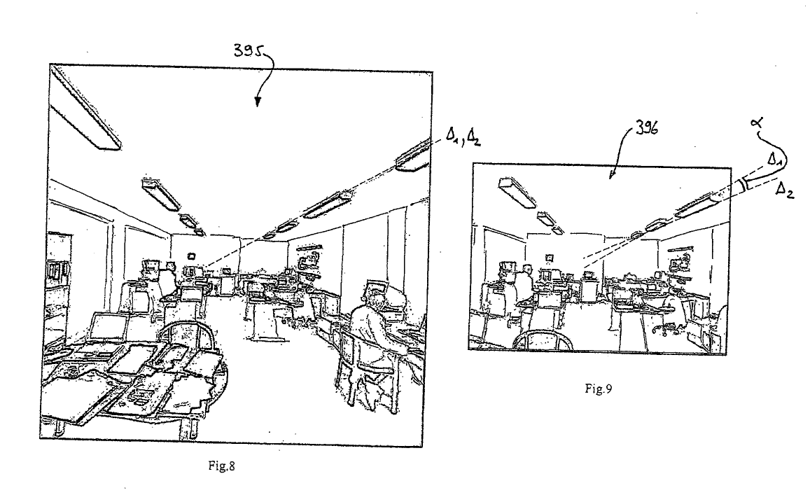

FIG. 9, a diagrammatic view of a fixed image obtained from the cylindrical projection of FIG. 7; and

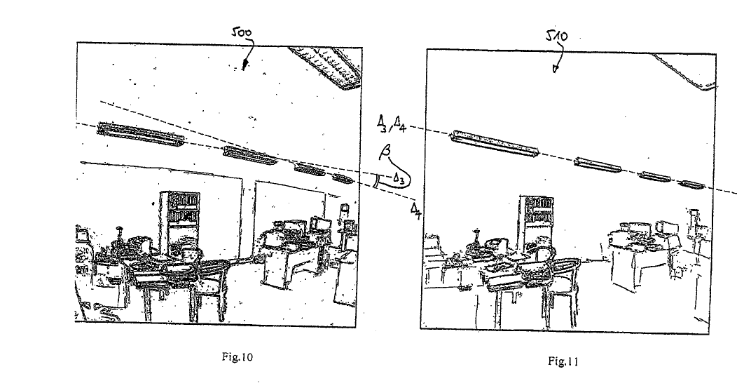

FIGS. 10 and 11, diagrammatic views of a fixed image obtained from a system according to the state of the art and a fixed image obtained from a cylindrical projection according to that of FIG. 7.

In the description that follows, the digital photographs used as an example are photographs taken with a digital camera with a very wide angle (180°×180°), commonly called fisheye. Naturally, the invention is not limited to these photographs but makes it possible to use any type of wide angle image.

A digital processing system according to the invention, the general structure of which is represented in FIG. 2, comprises:
an interface 100, that can be displayed on a computer 102 provided with a dual connection 104 to a communication network N, such as the Internet WWW, for collecting information and data, and for sending files;
a remote unit 200, for receiving and storing information and data files, linked via the communication network N to the interface 100 (link L1);
two data processing units 300, linked in parallel to the reception and storage unit by links N1 (possibly via the network N).

Other computers 100a or cellphone appliances 100b can be linked (links L3, L4) to the network N to make available thereon the virtual visit images by downloading or by HTML links.

The exposure can be the same as in the state of the art, but it is preferable to use a single specific exposure which consists in taking a single digital photograph 1 for each panoramic image required using a conventional digital camera 2 provided with a 180°×180° fisheye lens 3. Thus, the user no longer needs a stand to take a panoramic view 4: only what is behind him is not captured by his digital camera. By turning round and taking a second snapshot, he thus covers 360° in two exposures.

With the invention, the user no longer needs a joining program to be installed and learned with all the potential attendant constraints.

Also, once the different snapshots have been taken with his digital camera provided with the fisheye lens, the user simply has to connect to the web platform of the system according to the invention, then to transfer the digital photographs directly from the card of his digital camera and the rest of the operations are performed automatically according to the process described below.

In order to simplify the exposure, the use of a very wide-angle lens like a fisheye lens makes it possible to capture the image sufficiently to make a virtual visit and therefore avoid the need for the user to transport a stand and a ball joint, which are heavy and bulky pieces of equipment. The processing of such an image by a system according to the state of the art is complicated for a novice and requires in-depth learning. A system according to the invention makes it easy for any inexperienced user to use this type of image.

An interface according to the invention comprises:
a number of interactive areas for collecting information: an area 106 for selecting the images to be processed and an area 108 for identifying the image type;
an area 110 for activating a transfer program (or applet) able to divide the selected group of images into files containing only a limited number of images depending on their type.

According to one embodiment of the invention, the invention can include secure access.

The interactive area can be an interactive menu which is revealed in line with the information collection steps. This information can be, for example, the reference of the camera used, the reference of the wide-angle lens used.

A first optional phase—not represented in FIG. 3—consists in referencing the future virtual visit. This step makes it possible to qualify the virtual visit in order for it to be associated with text or criteria. This referencing sheet can vary depending on the type of user: a real estate agent, a travel agent, a car dealer, and so on.

A second phase, represented in FIG. 3, is the selection of the images: the user, in the step 120, activates a selection window and, in this window, in the step 122, selects the images to be transferred. Then, he identifies the type of the images, in the step 124: the user selects the images to be processed, for example in their order of appearance in the virtual visit, and gives their type, for example 180*180 or 360*180. Based on the determination of the image type, the transfer applet sends one or two images.

The interactive selection area 106 can filter, in the step 121, the selection of the images, in the step 122, by the user in order to accept only certain file formats such as, for example, the conventional image formats jpeg, gif, tif, png, eps, psd, and certain specific formats like, for example ipx, qtvr.

A sixth step 125 is activation of the area 110 for activating the transfer applet. The latter is used to transfer, in the step 126, all the images that will form the virtual visit. After this operation, the virtual visit is created automatically on the processing unit in a few seconds.

Depending on the image type (180° or 360°), the transfer program according to the invention transfers files comprising one image (180° type) or two images (360° type), to be processed. The processing file is generated by the transfer server once the image file has been fully downloaded.

The transfer program therefore divides the group of images selected by the user in the preceding steps into files containing only a limited number of images according to their type.

For example, when transferring eight 180°-type images, the applet transfers eight transfer files, each containing one image. Each time an image file is entirely received, the reception unit detects the format of the image, creates a processing file and sends them to a storage unit. Thus, the processing step can begin immediately a file arrives and does not need to wait for the arrival of all eight images to create the virtual visit.

According to a preferred embodiment, the transfer applet is able to determine, in the step 128, the transfer bit rate authorized by the network connection of the device and, in the step 130, to adapt the size of the images by compression according to the determined bit rate. Compression on the user's computer before sending means that the transfer proceeds more quickly.

It can therefore clearly be seen that the processing of several images can be performed jointly and not successively by a system according to the invention, because the transfer applet thus makes it possible to begin processing even while the transfer of all the images has not yet been completed.

The transfer applet sends the images to a reception and storage unit. In the embodiment represented in FIGS. 3 and 4, this unit consists of two separate units, a reception unit 200 and a storage unit 400 (FIG. 4). In this case, it is preferable for the storage unit 400 to also host the other data of the system such as the virtual visits created and the processing files (see below).

The reception unit comprises a digital processing circuit able to:
receive, in the step 210, images (1) taken with a camera (2) provided with a wide-angle lens (3);
automatically detect, in the step 215, the format of the images that it receives;
create a processing file, in the step 220, associated with the image comprising information concerning the format and the characteristics of the image and at least one processing operation to be performed; and
store the processing file 221 on the storage unit 400.

The detection of the format of the images is used to determine, in the step 240, whether this image must be processed. If the image is a fixed photograph, it will not be processed. If this image is a panoramic photograph or a fisheye photograph, it must be processed.

The images 231 are stored, in the step 230, on the storage unit 400.

The automatic detection of the format of the image can be done, for example, by comparing the value of the pixels of the image with a threshold value. For example, if it is a fisheye image, the reception unit detects the circle of the image and deletes the black pixel borders.

Once the format of the image is detected, the reception unit creates, in the step 220, a processing file 221 containing the information on the image format. This file can also contain information on the characteristics of the image, such as information collected on input to the interface 100 or EXIF (exchangeable image file) information extracted in the step 250: make, model and version of the software of the digital camera, compression type, resolution, exposure, aperture, exposure speed, focal length of the camera lens, and so on.

Finally, at least one image processing operation is specified, such as, for example, a projection of the wide angle images to distort them (equirectangular projection, Mercator projection, cylindrical projection, orthographic projection, Lambert-equivalent azimuth projection, stereographic projection, gnomonic projection, Lambert-compliant conical projection, sinusoidal projection, Bonne projection, Mollweide projection or a combination of the latter), a joining of several images, an inversion of the images, and so on.

The choice of projection depends on the lens type used and the place of the scene in the image that the user wants to emphasize. The choice of the projection is reserved for users skilled in a semiautomatic or manual mode of use of the system according to the invention. In automatic mode, the system performs three processing operations described below.

A processing file 221 can comprise one or several processing operations to be performed on an image. These processing operations are performed in a priority order to be defined in the system.

According to one preferred embodiment of the invention, there can be a number of processing files for one and the same image, each comprising a single processing operation to be performed.

The images 231 and the processing files 221 are stored on the separate storage unit 400. Preferably, the images 231 corresponding to the processing file or files 221 are copied before the processing files 221 to be sure of their presence at the time of processing.

Images 231 and processing files 221 are copied into an available storage directory by a netbios type sharing arrangement and mounted dynamically by the processing units.

As a general rule, the recovery of the images 231 makes it possible to process the images 231 as a critical flow in their order of arrival on the storage unit 400.

Also, this processing file transmits mandatory information that will condition the type of processing that the processing units 300 will apply.

The system according to the invention comprises (FIG. 2) two data processing units 300, linked in parallel to the reception and storage unit 200. When the storage is done by a separate storage unit, the processing units are linked in parallel to the storage unit 400.

Preferably, the processing units are Linux servers allowing for a precise adaptation of the source code of the operating system to reserve all the resources for the image processing. The use of a Windows (registered trademark) server leads to the use of some of the resources for ancillary programs. Furthermore, mounting or remounting in the event of disconnection from the storage directory is done automatically on Linux servers. This makes it possible to add processing units 300 easily without having to disconnect the system to cope with an increase in the number of processing operations. Each processing unit can be a blade of a blade server.

Each processing unit comprising a database and a digital processing circuit able to detect the presence of a new processing file; book access to this new file, process it according to the information contained in the database and the processing file to create a virtual visit, and make the virtual visit available to the user.

In the step 310, the processing units 300 perform an automatic and regular scan of the storage unit 400 as to the state of the storage directory present on the storage unit 400. If a new processing file appears, the processing units 300 check, in the steps 320, the processing files in order of priority. The processing files are then processed, for example, according to their extension determined by the processing operation. These extensions are, for example, in order of priority: “.vis” for priority processing, “.vis1” for the next processing, “.vis2” for the next processing, and so on.

The priorities are set according to the type of output image required and to obtain the best processing speed.

According to one embodiment, a processing unit 300 reserves, in the step 320, access to the processing file 221 that it has detected in the step 310, by renaming it so that another processing unit 300 can no longer identify it as a processing file. One possible means is to add to the extension characteristic of a processing file a character string generated by a GUID (global unique identifier) type system. Thus, the other processing units 300 cannot read the file 221 and perform the same processing operation. This enables the processing units 300 to begin their operations as and when the images 231 arrive while continuing to transfer other images.

Thus, the processing files 221 have a unique GUID name and normally contain: the number of images, the name of the images in order, the format of the images on input, the required output format, EXIF information if present, and so on.

The combination of the transfer program according to the invention and the reservation of each file by a single processing unit provides for a substantial saving in processing time.

Thus, when a first processing unit detects a first transfer file, it bars access to it to the other processing units and begins processing. In parallel, when a second transfer file arrives on the storage unit a second processing unit detects it, bars its access to the other processing units and begins processing the second transfer file. The same applies for the other six processing files.

As a comparative example, and assuming an average uplink transfer rate (ADSL) of 30 Kb/s, an image file with a size of 1 Mb and of 180° type, and a processing time for each image of 12 s, the transfer of eight images by a conventional transfer applet presents the following characteristics: the Java applet or the HTTP form transfers one or more files at one time. The processing unit that receives these files can process the images only once it has received all the files.

The result of the processing operation can appear only 6 minutes 3 seconds after being sent by the user:
transfer time: 8000 Kb/30 Kb=267 s
processing time: 12 s*8 images=96 s
total transfer time before the result is displayed: 267 s+96 s=363 s, or 6 min 3 s.

The transfer of eight images by a transfer applet according to the invention presents the following characteristics: the applet according to the invention proposes a multiple selection and transfers the files one by one for 180-type images. The processing unit processes these files as they arrive.

The result of the processing operation therefore appears 4 min 39 s after being sent by the user, or 24% more quickly:
transfer time for one image: 1000 Kb/30 Kb=33 s
total transfer time before display of the partial result (the last image transferred still has to be processed): 33 s×8 images=264 s
total transfer time before display of the total result: 264 s+12 s=276 s, or 4 min 39 s.

Thus, given these transfer conditions, the increase in speed is between approximately 13% (for the transfer of two images) and approximately 26% (for the transfer of a hundred images).

Three processing operations are performed by default by the system according to the invention: a conversion of wide angle images to be viewed by a Java display applet, a conversion of wide angle images so they can be viewed by a flash display applet and a conversion of wide angle images into fixed images for printing.

These processing operations are preceded by three preprocessing steps in a continuous flow. The first is a step 330 for copying the images into a local directory. The second is a step 332 for checking the content of the image to check its conformity: for example, the JPEG format (RVB/CMJN), the number of colors, the size, the presence of black borders, and so on. The processing unit also recovers the EXIF data if it exists to ascertain the value of the focal length and the type of camera. The link with a mapping table included in the database gives precisely the diameter being taken to have a square image with no black border. The processing time is thus minimized.

The third is a step 334 for cutting out the black borders of the images to obtain a square image or for recovering the image already cut out if it exists in the directory of image files on the storage unit.

Then, the processing unit 300, in the step 336, performs the processing operations in their order of priority. In the embodiment described, the priority processing operation is the conversion, in the step 350, of 180°-type circular fisheye images to be viewed by a Java display applet. This processing operation is as follows:
The processing unit 300 recovers the data concerning the lens and performs a geometrical conversion of the circular image obtained in the step 334 into an equirectangular image 352 (FIG. 2, link L5).
Then, the processing unit 300 performs a graphical correction if necessary—Gamma correction, attenuation filter etc.—and cuts out the widest possible square image without taking black borders.
If the processing operation consists in processing 360°-type images, the second image is processed in the same way and joined end-to-end (transversally or vertically depending on the scene) to the first.
Optionally, the processing unit, in the step 355, adds to the duly obtained image a skirt and a system copyright.
Finally, the processing unit 300 makes the virtual visit available to the user by creating, in the step 360, a miniature image in the default 300 dpi (dots per inch) jpg 4/3 format for display on the web, by copying, in the step 365, the images of the virtual visit into the image directory of the storage unit, and the miniature image into a thumbnails directory, and by archiving, in the step 370, the processing and ratio files in a directory 410 of the storage unit. The miniature image in the 4/3 format is created from images obtained in the virtual visit to notify the user that the processing of the image is complete. This image can also be used for printing by changing it to the 300 dpi CMJN EPS format.

The provision process will be detailed below.

According to one embodiment of the invention, the processing operation to be performed on several images during the processing step is an end-to-end joining of the images followed by an equirectangular projection of the joined images.

The second processing operation is the creation, in the step 380, of panoramic images 382 (FIG. 2) for display in a Flash display applet. This processing operation is as follows:
The processing unit 300 recovers the data concerning the lens and performs a geometrical conversion of the circular image obtained in the step 334 into an equirectangular image 352 (FIG. 2).
Then, the processing unit 300 performs, if necessary, a graphical correction—Gamma correction, attenuation filter, etc.—and cuts out a rectangular image in the centre of the equirectangular image, thus deleting the black parts and the top and bottom of the image. The rectangular image preferably represents half the image, the top and bottom parts each representing a quarter of the image. As a general rule, the cutting-out step deletes, at either end of the long side of the rectangular image, a portion of the image between 20% and 65% of the total image, preferably between 30% and 50%, typically between 35% and 45%. Above 65%, the image obtained is too small to be of good quality, below 20%, the distortion is not sufficiently corrected.
Finally, the processing unit 300 performs a spatial correction to distort the rectangular image consisting in extending the image in the direction of the long side and by a factor between 20% and 45%, preferably between 25% and 40%, typically between 30% and 35%, in order to obtain (FIG. 2, link L6) a panoramic image 382 with no distortion.

If the processing operation consists in processing 360°-type images, the second image is processed in the same way and joined transversally to the first.

The steps for making the panoramic image 382 available are the same as for the preceding processing operation by link L2 to the network N.

The third processing operation is the creation, in the step 390, of fixed images for high-quality printing on a paper medium (log, A4 sheet, etc.). The detailed steps are represented in FIGS. 5 to 9.
The processing unit 300 recovers the data concerning the lens and the square image 391 (FIG. 5) with no fisheye black borders, then cuts out a square image 392 (FIG. 6) centered on the image 391 and with a size roughly equal to half of the image to cover an angle of approximately 92°. The size of the image 392 depends on the desired viewing angle for the printed photograph: between 48° and 100°, preferably 75°. As a general rule, the size of the image 392 is chosen so that the maximum distortions of the borders of the image are excluded—viewing angle less than 100°. The same applies when using wide-angle images with a focal length less than 28. For wide-angle images with a focal length greater than 28, a barrel correction is sufficient to distort the image.
If necessary, the processing unit 300 performs a graphical correction—Gamma correction, attenuation filter, etc.
Then, the processing unit 300 performs a cylindrical projection 393 (FIG. 7) according to the angle of the lens used, and cuts out a square image 395 (FIG. 8) that is as large as possible by deleting the black areas 394 of the projection.

In the example illustrated, the lens used is a 183° FC-E8 fisheye lens associated with a Nikon CoolPix (registered trademark) 4300 camera. The image 394 represents an angle heightwise and widthwise of 183°/2=approximately 92°.

By comparison, an image 396 obtained with a processing operation according to the state of the art is represented in FIG. 9. This image presents two drawbacks: it covers only a small angle and presents a major geometrical distortion, which can be seen, in particular, by an offset in the alignment of the fluorescent lights which are, in reality, perfectly aligned.

The angle covered by the image 396 is calculated as follows:
the angle heightwise is equal to the angle of the fisheye lens divided by three, or 183°/3=61° vertically;
the angle widthwise is equal to the angle heightwise multiplied by four and divided by three. In other words, the angle widthwise is equal to the angle of the fisheye lens multiplied by four and divided by nine, or 61°×4/3=183°×4/9=approximately 81° horizontally.

In FIG. 9, a first fluorescent light in the background presents an alignment represented by the line Δ1, and a second fluorescent light presents an alignment represented by a line Δ2 forming a positive angle a with the line Δ2.

By contrast, in the image 395 obtained by the inventive system, the alignment of the fluorescent lights is perfectly rectilinear, the lines Δ1 and Δ2 being collinear.

Another example is represented in FIGS. 10 and 11, respectively representing an image 500 obtained with a correction according to the state of the art, and an image 510 obtained with a correction according to the invention.

In the image 500, the lines Δ3 and Δ4, representing the alignment of the fluorescent light on the left and the alignment of the fluorescent light on the right, form an angle β between themselves. By contrast, in the image 510, the lines Δ3 and Δ4 are collinear.

The user is notified that the processing operation is complete by the appearance of a miniature image on the interface. The speed of processing depends on the size of the images. The processing can be done simultaneously with several processing units connected and also simultaneously on one and the same processing units. The average processing time is 10 seconds for a 180×180 image with a DELL (registered trademark) Poweredge (registered trademark) 1850/Xeon (registered trademark) 3.2 GHz/2 Gb RAM biprocessor 1U Rack.

The processing operation is performed according to the parameters in the processing file “vis” and several procedures can exist in the case of errors in each of the processing steps.

If an error occurs during the processing operation, either the processing file is put back in the queue with a lower priority in the storage directory and is reprocessed several times until aborted in the event of repeated failure, or an image containing an error message is displayed in place of the miniature image and black images in the other directories where there is no image.

After the processing operation, the processing unit 300 stores the virtual visit on a storage unit 400 and provides the user with a means of accessing a display program and the virtual visit. This access means is a hypertext link enabling the user to open the virtual visit and run the display program which is stored on the remote storage unit 400 of the user's computer 102.

According to another embodiment of the system, the processing unit 300 sends the virtual visit and a program for displaying the virtual visit to the user, for storage on his computer.

Once the various images have been created to form the virtual visit, a multitude of services then allow, depending on the more conventional uses, for the virtual visit to be configured and used.

The interface according to the invention optionally allows for the images to be renamed and organized in an order of appearance in the virtual visit.

The user can, for example, define interactive areas on each image to move from one image to another: a door, a window, a closet, etc.

A service for broadcasting the virtual visit makes it possible to use the virtual visit to publish it on a website, send it by email to one or more correspondents, download it to a computer for burning on CDROM, send it to a cellphone, and so on.

The processing unit 300 creates a web page comprising a display program and a means of accessing the virtual visit, then sends this web page to an Internet site, an email address or a cellphone network.

This means of accessing the virtual visit is a hypertext link making it possible to open the virtual visit stored on a user's computer or on the remote storage unit 400.

Thus the virtual visit is displayed by activating an HTML link. The processing unit automatically and dynamically creates an HTML page comprising the parameterizing of a display program (JAVA, FLASH (registered trademark), QuickTime (registered trademark)) which enables calls to the storage unit to fetch the various images.

To preserve the confidentiality of the processing results, a system according to the invention provides encryption means when selecting the HTML link.

With a web interface, the user can enter the email address or addresses of his correspondent(s) for the system to send directly in the body of the email the HTML page (comprising the display elements of the virtual visit), or an HTML link to this page, or a pre-entered text associated with the HTML page in an attached file. This method of sending makes it possible to check that the recipient can, in all cases, see the virtual visit regardless of his email manager.

The user can also download each display element of the virtual image:
the original images (those that he has transferred)—the processed images
the fixed photographs (4/3 format) extracted from the panoramic images
the sheet to be printed in thumbnail form,
the virtual visit itself in different formats (Flash or Java).

In this case, preferably, the system creates a “.zip” or “.exe” file comprising the formatted HTML page in order to allow for it to be displayed without being connected to the Internet.

To improve the presentation of the virtual visit, a system according to the invention makes it possible to create an HTML page in A4 format comprising all the elements of the virtual visit. This page carries the textual elements that the user was able to enter when selecting images, and the images processed and restored—fixed images obtained by the third processing operation—in order to be able to print this page in high quality.

Two methods of broadcasting the virtual visit to one or more websites are possible:
Manual broadcast: the user can send a web master an email containing the procedure for incorporating the virtual visit on his website.
The email contains all the dynamic elements for calling the HTML page which reflects the parameterizing of the virtual visit. All he needs to do is copy the text from the email and insert it into the HTML page of the customer's site to see the virtual visit appear.
Automatic broadcast: when a user publishes his advertisements on an appropriate site, he indicates the reference of the advertisement to view his virtual visit on the site. This is made possible by the automated use of a web services system enabling the database of the appropriate site and that of the system's storage units to be synchronized.

A system according to the invention also makes it possible to send the advertisement information as well as the virtual visit to a cellphone. To be compatible with most cellphones, the system provides, with the virtual visit, a display program suited to the various market standard systems:
JAVA MIDP 1.0 viewer (world standard)
JAVA DOJA 1.5 viewer (NTT Docomo standard)
Flash Lite viewer (Pocket PC and 3G phone compatible)
WAP viewer.

To use this service, it is essential to enter the number of the correspondent in a field provided for this purpose in the interface. Depending on the network used by the telephone, an email or an SMS is sent with a connection link which enables the correspondent, provided he has an Internet connection via his telephone, to access the virtual visit.

The invention makes it possible, from multiple input image formats (one fisheye image, two fisheye images, a panoramic image, several wide-angle images) to automatically create as output:
a virtual visit for the Internet comprising at least one panoramic image;
a fixed image suitable for high-quality printing;
a thumbnail image for display on websites or in the press;
a virtual visit in cellphone format.

Also, as a general rule, and using a digital camera provided with a fisheye lens, the user takes a photograph for each site that he wants to represent and the system according to the invention creates the visual content suited to the output media, each time re-using all the photographs that the user has taken.

According to other embodiments of the invention:
The transfer applet can create a file for each image regardless of type, and begin processing only when the corresponding number of files is fully transferred; one if the image type is 180°, two if the image type is 360°.
The number of images necessary for processing is determined according to the image type. Consequently, 120°-type wide-angle images must be received in threes to produce a 360°-type virtual visit. Thus, the number of images that must be received for the processing operation to be able to begin is equal to the typical ratio of the virtual visit/image type. Thus, for a virtual visit of 360° type, three 120°-type images, or four 90°-type images will be needed.
The interface of a system according to the invention can be displayed on a personal digital assistant or multimedia television provided with an Internet connection. The display device needs to be able to allow for display of large image files by known display programs.
According to one embodiment, the reception and storage unit comprises a digital circuit able to rename each received image uniquely, for example using a GUID (Global Unit Identifier) type system. This unique name is retained throughout the processing operation and makes it possible to avoid confusion and/or overwriting of the data in the system. Thus, two virtual visits cannot have the same name. The system according to the invention can therefore be reproduced by different companies on line, without risking conflict between the virtual visits on one and the same publication site.

According to an embodiment, the display applet comprises a zoom function performing a polynomial interpolation to avoid pixelization when the zoom factor is increased.

1. A method for the bulk production of interactive virtual visits for multimedia broadcast based on at least one image selected by a user having a computer provided with a network connection, comprising:
(a) receiving, on a reception and storage unit, via an interface that can be displayed on the computer provided with a network connection, images taken with digital cameras provided with a wide-angle lens,
(b) automatically detecting the format of each image;
(c) creating a processing file associated with at least one image comprising information concerning the image format and characteristics and at least one processing operation to be performed;
(d) performing a scan that is automatic and at a regular frequency of the reception and storage unit with a processing unit, to immediately detect the presence of a new processing file associated with one or more images;
(e) as soon as a processing unit detects a new processing file, renaming it automatically and uniquely with the processing unit;
(f) processing as a continuous stream the associated image or images according to the processing read by the processing unit in the processing file, to perform a correction of distortion of the image so that it can be read as a virtual visit by a display program;
(g) making the virtual visit available to the user.

2. The method for the bulk production of interactive virtual visits as claimed in claim 1, in which the step (a) comprises a step for selection by the user of a group of images, a step for selection by the user of the type of the images, and a step of dividing the selected group of images into files containing only a limited number of images according to their type.

3. The method for the bulk production of interactive virtual visits as claimed in claim 1, in which the step (a) also comprises the action, by the reception and storage unit, of renaming each image received uniquely.

4. The method for the bulk production of interactive virtual visits as claimed in claim 1, in which the processing unit, having detected the new processing file, renames it, during the step (e), by modifying its name randomly so that another processing unit can no longer identify it as a processing file.

5. The method for the bulk production of interactive virtual visits as claimed in claim 1, in which the step (g) includes storing the virtual visit on a storage unit and supplying the user with a means of accessing a display program and the virtual visit.

6. The method for the bulk production of interactive virtual visits as claimed in claim 1, in which the step (g) includes sending to the user, for storage on his computer, the virtual visit and a program for displaying the virtual visit.

7. The method for the bulk production of interactive virtual visits as claimed in claim 1, in which the step (g) also includes:
creating a web page comprising a display program and a means of accessing the virtual visit;
sending this web page to a website, an email or a cellphone network.

8. The method for the bulk production of interactive virtual visits as claimed in claim 5, in which the means of accessing a display program and the virtual visit is a hypertext link enabling the user to open the virtual visit and run the display program which are stored on a remote storage unit of the user's computer.

9. The method for the bulk production of interactive virtual visits as claimed in claim 7, in which the means of accessing the virtual visit is a hypertext link making it possible to open the virtual visit stored on a user's computer or on a remote storage unit.

10. The method for the bulk production of interactive virtual visits as claimed in claim 1, in which the processing operation to be performed on an image during the step (f) is an equirectangular projection to obtain an equirectangular image.

11. The method for the bulk production of interactive virtual visits as claimed in claim 1, in which the processing operation to be performed on several images during the step (f) is an equirectangular projection of each image, followed by an end-to-end joining of the equirectangular images obtained.

12. The method for the bulk production of interactive virtual visits as claimed in claim 1, in which the processing operation to be performed on several images during the step (f) is an end-to-end joining of the images followed by an equirectangular projection of the joined images.

13. The method for the bulk production of interactive virtual visits as claimed in claim 1, in which the processing operation produces a panoramic image by performing the steps consisting in:
performing an equirectangular projection of the wide angle image, to obtain an equirectangular image,
subdividing a rectangular image so as to delete, on either side of the large dimension direction of the rectangular image, a portion of the image between 20% and 65% of the total image.
performing a spatial correction to distort the rectangular image comprising extending the image in the direction of the long side and by a factor between 20% and 45%.

14. The method for the bulk production of interactive virtual visits as claimed in claim 1, in which the processing operation produces a fixed image for high-quality printing, by performing the steps of:
cutting out an image centered on the wide angle image, the size of the centered image being chosen so that the deformations of the edges of the wide angle image are excluded;
performing a cylindrical projection of the cut-out image, and cutting out an image so as to delete the black areas of the projection.

15. The method for the bulk production of interactive virtual visits as claimed in claim 1, in which the processing operation to be performed comprises a projection taken from the group consisting of:
an equatorial projection such as an equirectangular projection, a Mercator projection or a cylindrical projection,
an azimuth projection such as an orthographic projection, a Lambert-equivalent projection, a stereographic projection or a gnomonic projection,
a Lambert-compliant conical projection,
a sinusoidal projection,
a Bonne projection,
a Mollweide projection,
and a combination of the latter.

16. A digital processing system comprising:
an interface that can be displayed on a computer provided with a network connection, for collecting information and data and sending files;
a remote reception and storage unit for processing files and data files linked by a communication network (N) to the interface;
at least one data processing unit, linked to the reception and storage unit, in parallel in the case of at least two processing units, each processing unit comprising a database and a digital processing circuit able to detect the presence of a new processing file, reserve access to this new file, process the data according to the information contained in the database and in the processing file to create a virtual visit, and make the virtual visit available to the user.

17. The digital processing system as claimed in claim 16, in which the interface comprises:
at least one interactive area for collecting information comprising an area for selecting the images to be processed and an area for identifying the image type;
an area for activating a transfer program able to divide the selected group of images into files containing only a limited number of images according to their type.

18. The digital processing system as claimed in claim 17, in which the interactive selection area also comprises an authorized image format filter.

19. The digital processing system as claimed in claim 16, in which the transfer program is able to determine the transfer bit rate authorized by the network connection of the device and adapt the size of the images by compression according to the determined bit rate.

20. The digital processing system as claimed in claim 16, in which the remote reception and storage unit comprises a digital processing circuit able to:
automatically detect the format of the image;
create a processing file associated with the image comprising information concerning the format and the characteristics of the image and at least one processing operation to be performed; and
store the processing file.

21. The digital processing system as claimed in claim 16, also comprising at least one storage unit for the virtual visits.

22. The digital processing system as claimed in claim 16, in which the reception and storage unit comprises a reception unit and a storage unit that are separate.

23. The digital processing system as claimed in claim 16, in which the storage unit is also used to store the images to be processed and the virtual visits.

24. The digital processing system as claimed in claim 16, in which the processing unit comprises a digital processing circuit able to detect a new processing file on the storage unit, and rename it, so that another processing unit can no longer identify it as a processing file.

25. The digital processing system as claimed in claim 16, in which the processing unit comprises a digital processing circuit able to automatically create a publication of the virtual visit to the Internet network, to at least one electronic address or to a cellphone network.

26. The digital processing system as claimed in claim 16, in which encryption means are provided to ensure the confidentiality of the images and of each virtual visit created.
